(19) United States
(12) Patent Application Publication
(10) Pub. No.: US 2022/0113171 A1
(43) Pub. Date: Apr. 14, 2022

(54) SENSOR DIAGNOSIS DEVICE AND COMPUTER READABLE MEDIUM

(71) Applicant: MITSUBISHI ELECTRIC CORPORATION, Tokyo (JP)

(72) Inventor: Toshihito IKENISHI, Tokyo (JP)

(73) Assignee: MITSUBISHI ELECTRIC CORPORATION, Tokyo (JP)

(21) Appl. No.: 17/560,844

(22) Filed: Dec. 23, 2021

Related U.S. Application Data
(63) Continuation of application No. PCT/JP2019/029756, filed on Jul. 30, 2019.

(51) Int. Cl. G01D 18/00; G01D 21/02; G01S 7/40; G01S 7/497; G01S 7/52

(52) U.S. Cl. CPC G01D 18/00; G01D 21/02; G01S 7/52004; G01S 7/497; G01S 7/40

(57) ABSTRACT

A data acquisition unit (110) acquires a sensor data group from a sensor group (200) including a plurality of sensors of different types. An object detection unit (120) calculates a position information group of an object existing in an area surrounding the sensor group based on the acquired sensor data group. An environment determination unit (130) determines an environment of the area surrounding the sensor group based on at least one piece of sensor data in the acquired sensor data group. A normal range decision unit (140) decides a normal range for the calculated position information group based on the determined environment. A state determination unit (150) determines a state of the sensor group based on the calculated position information group and the decided normal range.

### CROSS REFERENCE TO RELATED APPLICATIONS

This application is a Continuation of PCT International Application No. PCT/JP2019/029756 filed on Jul. 30, 2019, which is hereby expressly incorporated by reference into the present application.

### TECHNICAL FIELD

The present invention relates to a technology to diagnose a sensor.

### BACKGROUND ART

Conventional anomaly diagnosis devices are proposed as devices that can detect that a system is not normal even in a case where an unknown anomaly has occurred.

Patent Literature 1 discloses a diagnosis device as described below. For this diagnosis device, a normal system model is created based on sensor data and a relationship among a plurality of sensors when a system is normal. This diagnosis device compares a value of a relationship between each pair of sensors obtained based on the current sensor data with a value of the normal model. Then, this diagnosis device diagnoses an anomaly when a deviate value is observed, and in this case determines that the system is not normal.

### CITATION LIST

### Patent Literature

Patent Literature 1: JP 2014-148294 A

### SUMMARY OF INVENTION

### Technical Problem

Conventionally, a normal model is created based on sensor output values and a relationship among a plurality of sensors, and a diagnosis device diagnoses an anomaly of a sensor based on a deviation level which indicates how much a value of the current relationship among the plurality of sensors is deviated from the relationship in the normal model.

However, it is conceivable that even if the sensors are normal, the amount of variations in measurement accuracy varies with the environment of a surrounding area, such as weather (sunny, rain, fog, etc.) or the time of day (morning, noon, night, etc.).

Therefore, an appropriate deviation level is not obtained unless the environment of the surrounding area is taken into account, so that the sensors cannot be accurately diagnosed.

An object of the present invention is to make it possible to perform an accurate diagnosis that takes into account the environment of a surrounding area.

### Solution to Problem

A sensor diagnosis device according to the present invention includes

a data acquisition unit to acquire a sensor data group from a sensor group including a plurality of sensors of different types;

an object detection unit to calculate a position information group of an object existing in an area surrounding the sensor group based on the acquired sensor data group;

an environment determination unit to determine an environment of the area surrounding the sensor group based on at least one piece of sensor data in the acquired sensor data group;

a normal range decision unit to decide a normal range for the calculated position information group based on the determined environment; and

a state determination unit to determine a state of the sensor group based on the calculated position information group and the decided normal range.

### Advantageous Effects of Invention

According to the present invention, an accurate diagnosis that takes into account the environment of a surrounding area can be performed.

### BRIEF DESCRIPTION OF DRAWINGS

FIG. 1 is a configuration diagram of a sensor diagnosis device 100 in a first embodiment;

FIG. 2 is a flowchart of a sensor diagnosis method in the first embodiment;

FIG. 3 is a flowchart of a normal range decision process (S140) in the first embodiment;

FIG. 4 is a flowchart of a state determination process (S150) in the first embodiment;

FIG. 5 is a diagram illustrating error ranges of position information in the first embodiment;

FIG. 6 is a flowchart of a parameter generation method in the first embodiment;

FIG. 7 is a diagram illustrating normal distributions of position information in the first embodiment;

FIG. 8 is a diagram illustrating changes in a deterioration level of a sensor group 200 in the first embodiment;

FIG. 9 is a flowchart of a sensor diagnosis method in a second embodiment;

FIG. 10 is a flowchart of a normal range decision process (S240) in the second embodiment;

FIG. 11 is a flowchart of a state determination process (S250) in the second embodiment;

FIG. 12 is a flowchart of a parameter generation method in the second embodiment;

FIG. 13 is a diagram illustrating principal components of position information in the second embodiment;

FIG. 14 is a diagram illustrating normal distributions of position feature values in the second embodiment;

FIG. 15 is a diagram of comparison between distributions of position information and distributions of position feature values in the second embodiment;

FIG. 16 is a flowchart of a sensor diagnosis method in a third embodiment;

FIG. 17 is a flowchart of a normal range decision process (S340) in the third embodiment;

FIG. 18 is a diagram illustrating a relationship graph in the third embodiment;

FIG. 19 is a diagram illustrating an approximate curve in the third embodiment;

FIG. 20 is a flowchart of a sensor diagnosis method in a fourth embodiment;

FIG. 21 is a flowchart of a normal range decision process (S440) in the fourth embodiment; and

FIG. 22 is a hardware configuration diagram of the sensor diagnosis device 100 in the embodiments.

### DESCRIPTION OF EMBODIMENTS

In the embodiments and drawings, the same elements or corresponding elements are denoted by the same reference sign. Description of an element denoted by the same reference sign as that of an element that has been described will be omitted or simplified as appropriate. Arrows in the drawings mainly indicate flows of data or flows of processing.

### First Embodiment

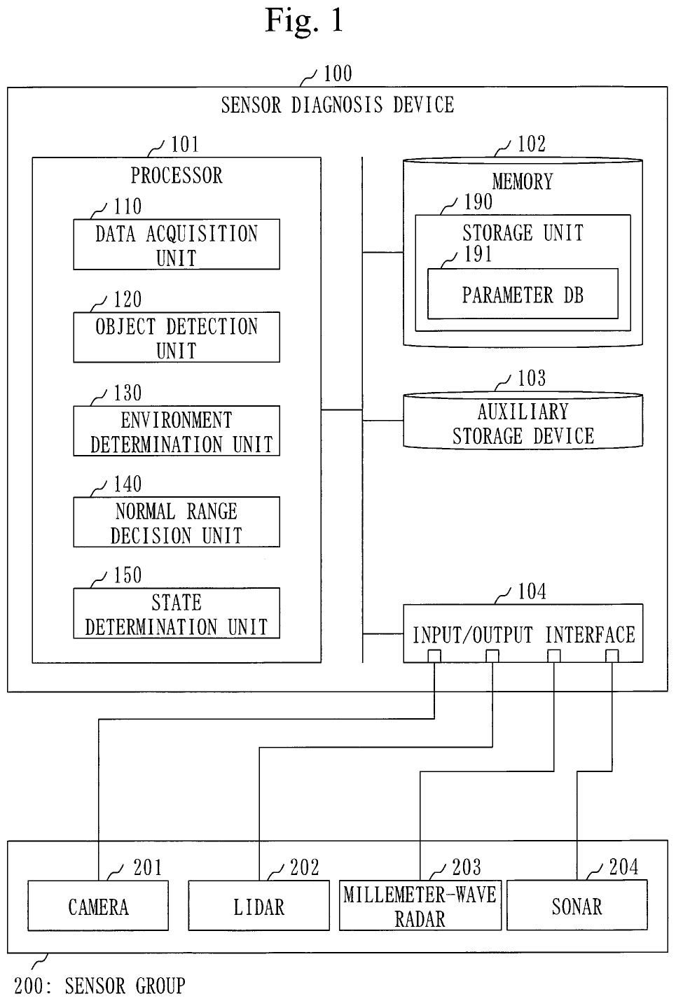

Based on FIGS. 1 to 8, a sensor diagnosis device 100 will be described.

### Description of Configuration

Based on FIG. 1, a configuration of the sensor diagnosis device 100 will be described.

The sensor diagnosis device 100 is a computer to diagnose a sensor group 200.

For example, the sensor diagnosis device 100 is mounted on a mobile object together with the sensor group 200 and determines the state (normal or anomalous) of the sensor group 200 while the mobile object is moving or while the mobile object is at rest. Specific examples of the mobile object are an automobile, a robot, and a ship. An ECU mounted on the mobile object may function as the sensor diagnosis device 100.

ECU is an abbreviation for Electronic Control Unit.

The sensor group 200 includes a plurality of sensors of different types. A plurality of sensors of the same type may be included in the sensor group 200.

Specific examples of a sensor are a camera 201, a LIDAR 202, a millimeter-wave radar 203, and a sonar 204.

The sensor group 200 is used to observe the environment of a surrounding area and objects existing in the surrounding area.

Specific examples of the environment are weather (sunny, rain, fog, etc.) and brightness. Brightness provides an indication of the time of day such as daytime or evening. Brightness also provides an indication of the presence or absence of backlight. The reflectivity of an object in a measurement by the LIDAR 202, the millimeter-wave radar 203, or the sonar 204 is also an example of the environment. These environments affect the field of view of each sensor. That is, these environments affect a measurement by each sensor.

Specific examples of an object are another vehicle, a passenger, and a building.

The sensor diagnosis device 100 includes hardware components such as a processor 101, a memory 102, an auxiliary storage device 103, and an input/output interface 104. These hardware components are connected with one another via signal lines.

The processor 101 is an IC that performs operational processing, and controls other hardware components. For example, the processor 101 is a CPU, a DSP, or a GPU.

IC is an abbreviation for Integrated Circuit.

CPU is an abbreviation for Central Processing Unit.

DSP is an abbreviation for Digital Signal Processor.

GPU is an abbreviation for Graphics Processing Unit.

The memory 102 is a volatile or non-volatile storage device. The memory 102 is also called a main storage device or a main memory. For example, the memory 102 is a RAM. Data stored in the memory 102 is saved to the auxiliary storage device 103 as necessary.

RAM is an abbreviation for Random Access Memory.

The auxiliary storage device 103 is a non-volatile storage device. For example, the auxiliary storage device 103 is a ROM, an HDD, or a flash memory. Data stored in the auxiliary storage device 103 is loaded into the memory 102 as necessary.

ROM is an abbreviation for Read Only Memory.

HDD is an abbreviation for Hard Disk Drive.

The input/output interface 104 is a port to which various devices are connected. The sensor group 200 is connected to the input/output interface 104.

The sensor diagnosis device 100 includes elements such as a data acquisition unit 110, an object detection unit 120, an environment determination unit 130, a normal range decision unit 140, and a state determination unit 150. These elements are realized by software.

The auxiliary storage device 103 stores a sensor diagnosis program for causing a computer to function as the data acquisition unit 110, the object detection unit 120, the environment determination unit 130, the normal range decision unit 140, and the state determination unit 150. The sensor diagnosis program is loaded into the memory 102 and executed by the processor 101.

The auxiliary storage device 103 further stores an OS. At least part of the OS is loaded into the memory 102 and executed by the processor 101.

The processor 101 executes the sensor diagnosis program while executing the OS.

OS is an abbreviation for Operating System.

Input/output data of the sensor diagnosis program is stored in a storage unit 190. For example, a parameter database 191 and so on are stored in the storage unit 190. The parameter database 191 will be described later.

The memory 102 functions as the storage unit 190. However, storage devices such as the auxiliary storage device 103, a register in the processor 101, and a cache memory in the processor 101 may function as the storage unit 190 in place of the memory 102 or together with the memory 102.

The sensor diagnosis device 100 may include a plurality of processors as an alternative to the processor 101. The plurality of processors share the functions of the processor 101.

The sensor diagnosis program can be recorded (stored) in a computer readable format in a non-volatile recording medium such as an optical disc or a flash memory.

### Description of Operation

A procedure for operation of the sensor diagnosis device 100 is equivalent to a sensor diagnosis method. The procedure for operation of the sensor diagnosis device 100 is also equivalent to a procedure for processing by the sensor diagnosis program.

Each sensor in the sensor group 200 performs a measurement and outputs sensor data at each time point.

The camera 201 captures an image of a surrounding area and outputs image data at each time point. The image data is data of the image in which the surrounding area is captured.

The LIDAR 202 emits laser light to the surrounding area and outputs point cloud data at each time point. The point cloud data indicates a distance vector and a reflection intensity for each point at which the laser light is reflected.

The millimeter-wave radar 203 emits a millimeter wave to the surrounding area and outputs distance data at each time point. This distance data indicates a distance vector for each point at which the millimeter wave is reflected.

The sonar 204 emits a sound wave to the surrounding area and outputs distance data at each time point. This distance data indicates a distance vector for each point at which the sound wave is reflected.

Each of image data, point cloud data, and distance data is an example of sensor data.

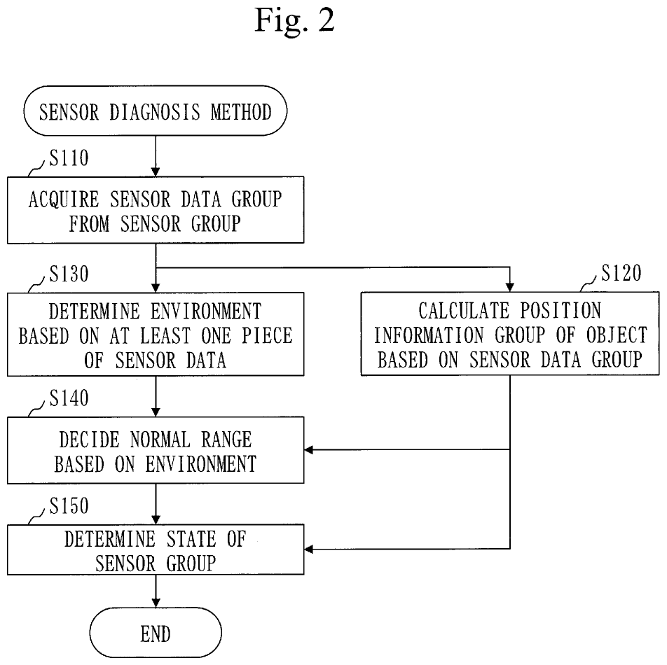

Based on FIG. 2, a sensor diagnosis method will be described.

Step S110 to step S150 are executed at each time point. That is, step S110 to step S150 are executed repeatedly.

In step S110, the data acquisition unit 110 acquires a sensor data group from the sensor group 200.

That is, the data acquisition unit 110 acquires sensor data from each sensor in the sensor group 200.

In step S120, the object detection unit 120 calculates a position information group of an object based on the sensor data group.

A position information group of an object is one or more pieces of position information of the object.

Position information of an object is information that identifies the position of the object. Specifically, position information is a coordinate value. For example, position information is a coordinate value in a local coordinate system, that is, a coordinate value that identifies a position relative to the position of the sensor group 200. The coordinate value may be a one-dimensional value (x), two-dimensional values (x, y), or three-dimensional values (x, y, z).

A position information group of an object is calculated as described below.

The object detection unit 120 performs data processing on each piece of sensor data. By this, the object detection unit 120 detects an object and calculates a coordinate value of the object from each piece of sensor data. At this time, for detecting an object and calculating the coordinate value of the object, conventional data processing can be used according to the type of the sensor data.

If a plurality of objects are detected, each object is identified and the coordinate value of each object is calculated.

At least one piece of position information may be calculated by sensor fusion. In sensor fusion, there are various methods such as early fusion, cross fusion, and late fusion. Various combinations of sensors are conceivable, such as the camera 201 and the LIDAR 202, the LIDAR 202 and the millimeter-wave radar 203, as well as the camera 201 and the millimeter-wave radar 203.

When sensor fusion is used, the object detection unit 120 calculates one piece of position information, using two or more pieces of sensor data obtained from two or more sensors. The method of sensor fusion for this calculation may be any method. For example, the object detection unit 120 calculates position information for each piece of sensor data, and calculates the average of the calculated position information. The calculated average is used as position information calculated by sensor fusion.

In step S130, the environment determination unit 130 determines the environment based on at least one piece of sensor data.

The environment is determined as described below.

First, the environment determination unit 130 selects one sensor.

Next, the environment determination unit 130 performs data processing on sensor data acquired from the selected sensor. At this time, for determining the environment, conventional data processing can be used according to the type of the sensor data.

Then, the environment determination unit 130 determines the environment based on the result of the data processing.

One sensor is selected as described below.

The environment determination unit 130 selects a predetermined sensor. The environment determination unit 130 may select a sensor based on the environment of the previous time. For example, the environment determination unit 130 can use a sensor table to select a sensor corresponding to the environment of the previous time. The sensor table is a table in which environments and sensors are associated with each other, and is prestored in the storage unit 190.

The environment may be determined by sensor fusion. In sensor fusion, there are various methods such as early fusion, cross fusion, and late fusion. Various combinations of sensors are conceivable, such as the camera 201 and the LIDAR 202, the LIDAR 202 and the millimeter-wave radar 203, as well as the camera 201 and the millimeter-wave radar 203.

In this case, the environment determination unit 130 selects two or more sensors, and determines the environment using two or more pieces of sensor data acquired from the two or more selected sensors. The method of sensor fusion for this determination may be any method. For example, the environment determination unit 130 determines the environment from each piece of sensor data, and decides the environment by majority decision based on the determination results.

In step S140, the normal range decision unit 140 decides a normal range based on the environment determined in step S130.

The normal range is a range of normal position information. When the sensor group 200 is normal, each piece of position information calculated in step S120 is within the normal range.

If a plurality of objects are detected in step S120, the normal range is decided for each object.

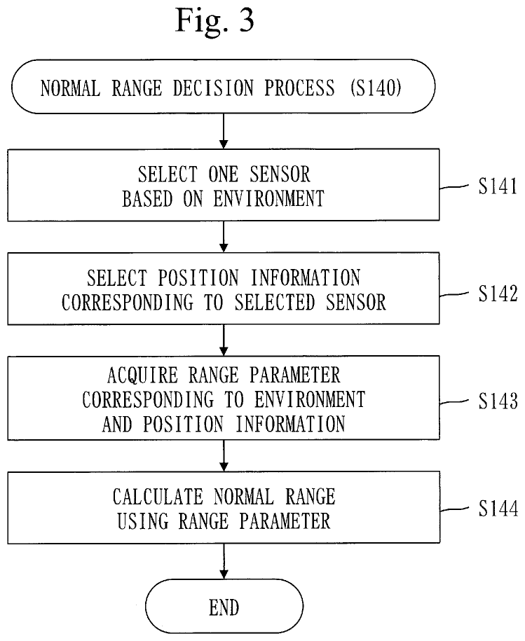

Based on FIG. 3, a procedure for a normal range decision process (S140) will be described.

In step S141, the normal range decision unit 140 selects one sensor based on the environment determined in step S130.

For example, the normal range decision unit 140 uses a sensor table to select a sensor corresponding to the environment. The sensor table is a table in which environments and sensors are associated with each other, and is prestored in the storage unit 190.

In step S142, the normal range decision unit 140 selects position information corresponding to the sensor selected in step S141 from the position information group calculated in step S120.

That is, the normal range decision unit 140 selects position information calculated using sensor data acquired from the selected sensor.

In step S143, the normal range decision unit 140 acquires, from the parameter database 191, a range parameter corresponding to the environment determined in step S130 and the position information selected in step S142.

The range parameter is a parameter for deciding a normal range.

In the parameter database 191, a range parameter is registered for each combination of environment information and position information.

For example, the normal range decision unit 140 acquires, from the parameter database 191, a range parameter corresponding to environment information indicating the environment determined in step S130 and position information of a position closest to the position identified by the position information selected in step S142.

In step S144, the normal range decision unit 140 calculates a normal range using the range parameter acquired in step S143.

The normal range is calculated as described below.

The range parameter indicates a distribution of normal position information. For example, the range parameter is the average of normal position information and the standard deviation (σ) of normal position information.

The normal range decision unit 140 calculates the normal range according to the distribution of normal position information. For example, the normal range decision unit 140 calculates a range of the average ±2σ. The calculated range is used as the normal range. Note that “1σ”, “3σ”, or the like may be used in place of “2σ”.

Referring back to FIG. 2, step S150 will be described.

In step S150, the state determination unit 150 determines the state of the sensor group 200 based on the position information group calculated in step S120 and the normal range decided in step S140.

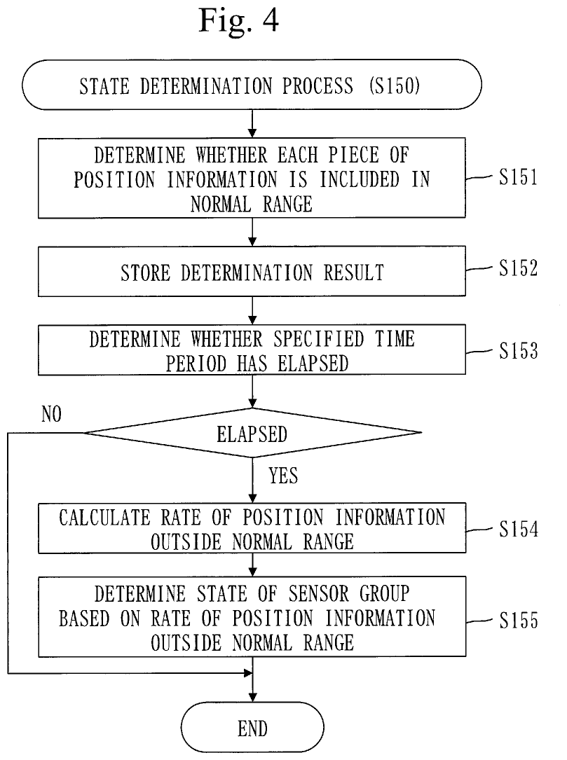

Based on FIG. 4, a procedure for a state determination process (S150) will be described.

In step S151, the state determination unit 150 compares each piece of position information calculated in step S120 with the normal range decided in step S140.

Then, based on the comparison result, the state determination unit 150 determines whether each piece of position information calculated in step S120 is included in the normal range decided in step S140.

If a plurality of objects are detected in step S120, the state determination unit 150 determines, for each object, whether each piece of position information is included in the normal range.

In step S152, the state determination unit 150 stores the determination results obtained in step S151 in the storage unit 190.

In step S153, the state determination unit 150 determines whether a specified time period has elapsed. This specified time period is a time period predetermined for the state determination process (S150).

For example, the state determination unit 150 determines whether the specified time period has newly elapsed from the previous time point when the specified time period had elapsed.

If the specified time period has elapsed, processing proceeds to step S154.

If the specified time period has not elapsed, the state determination process (S150) ends.

In step S154, the state determination unit 150 calculates a rate of position information outside the normal range using the determination results stored in step S152 during the specified time period.

In step S155, the state determination unit 150 determines the state of the sensor group 200 based on the rate of position information outside the normal range.

If it is determined that the sensor group 200 is anomalous, at least one sensor in the sensor group 200 is considered to be anomalous.

The state of the sensor group 200 is determined as described below.

The state determination unit 150 compares the rate of position information outside the normal range with a rate threshold. This rate threshold is a threshold predetermined for the state determination process (S150).

If the rate of position information outside the normal range is greater than the rate threshold, the state determination unit 150 determines that the sensor group 200 is anomalous.

If the rate of position information outside the normal range is smaller than the rate threshold, the state determination unit 150 determines that the sensor group 200 is normal.

If the rate of position information outside the normal range is equal to the rate threshold, the state determination unit 150 may determine that the sensor group 200 is anomalous or may determine that the sensor group 200 is normal.

### Supplement to First Embodiment

The parameter database 191 will be supplementarily described below.

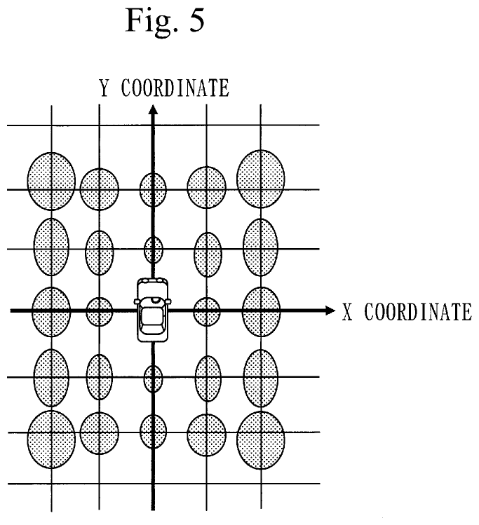

FIG. 5 illustrates error ranges for position information of objects detected by the sensor group 200 that is normal. For example, the sensor group 200 is mounted on an automobile.

A shaded range indicated at each intersection represents an error range for position information of an object detected by the sensor group 200 that is normal when the object is located at the intersection.

Even if the sensor group 200 is normal, errors occur in measurements by the sensor group 200. For this reason, errors occur in a position information group calculated based on a sensor data group. Furthermore, the size of the error range varies depending on the position of the object. For example, it is considered that the further away the position of the object, the larger the error range. It is also considered that the size of the error range varies depending on the environment (weather, brightness, or the like).

In the sensor diagnosis method, the normal range is equivalent to the error range. The normal range is decided based on the environment of the surrounding area and the position information of the object, so that the state of the sensor group 200 can be accurately determined.

In the parameter database 191, a range parameter is registered for each combination of environment information and position information.

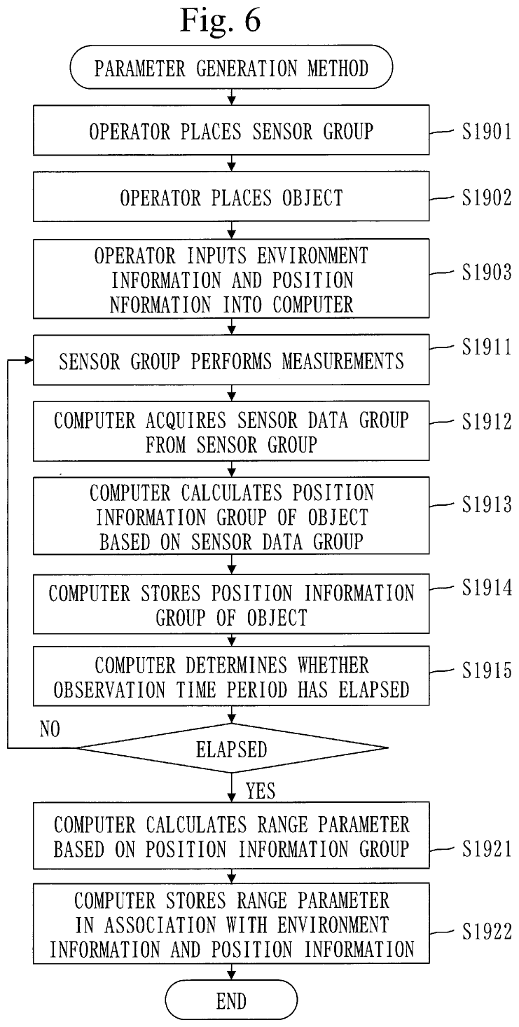

Based on FIG. 6, a parameter generation method will be described.

The parameter generation method is a method for generating a range parameter.

In the following description, an “operator” is a person who performs work for carrying out the parameter generation method. A “computer” is a device to generate a range parameter (parameter generation device). A “sensor group” is a group of sensors that is identical to the sensor group 200 or a group of sensors of the same types as those in the sensor group 200.

In step S1901, the operator places the sensor group and connects the sensor group to the computer.

In step S1902, the operator decides a position of object and places an object at the decided position.

In step S1903, the operator inputs environment information that identifies the environment of the place into the computer. The operator also inputs position information that identifies the position where the object is placed into the computer.

In step S1911, each sensor in the sensor group performs a measurement.

Step S1912 is substantially the same as step S110.

In step S1912, the computer acquires a sensor data group from the sensor group.

Step S1913 is substantially the same as step S120.

In step S1913, the computer calculates a position information group of the object based on the sensor data group.

In step S1914, the computer stores the position information group of the object.

In step S1915, the computer determines whether an observation time period has elapsed. This observation time period is a time period predetermined for the parameter generation method.

For example, the computer determines whether the observation time period has elapsed since the time point when the sensor data group of the first time is acquired from the sensor group in step S1912.

If the observation time period has elapsed, processing proceeds to step S1921.

If the observation time period has not elapsed, processing proceeds to step S1911.

In step S1921, the computer calculates a range parameter based on one or more position information groups stored in step S1914 during the observation time period.

The range parameter is calculated as described below.

First, the computer calculates a normal distribution for one or more position information groups.

Then, the computer calculates the average in the calculated normal distribution. Furthermore, the computer calculates the standard deviation in the calculated normal distribution. A set of the calculated average and the calculated standard deviation is used as the range parameter.

However, the computer may calculate a probability distribution other than the normal distribution. The computer may calculate a range parameter different from the set of the average and the standard deviation.

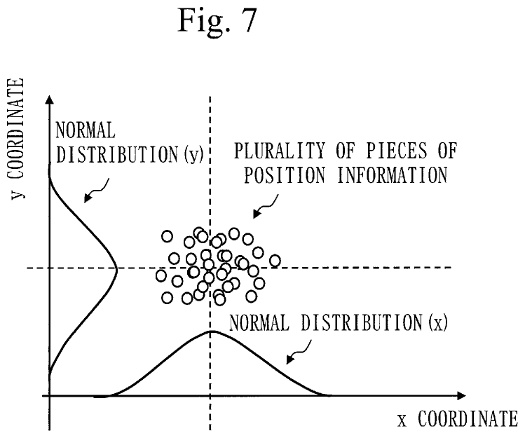

FIG. 7 illustrates a relationship among a plurality of pieces of position information, a normal distribution (x), and a normal distribution (y).

The plurality of pieces of position information constitute one or more position information groups.

One blank circle represents one piece of position information. Specifically, a blank circle represents two-dimensional coordinate values (x, y). The normal distribution (x) is the normal distribution on the x coordinate. The normal distribution (y) is the normal distribution on the y coordinate.

For example, the computer calculates the normal distribution (x) and the normal distribution (y) for the plurality of pieces of position information. Then, the computer calculates a set of the average and the standard deviation for each of the normal distribution (x) and the normal distribution (y).

Referring back to FIG. 6, step S1922 will be described.

In step S1922, the computer stores the range parameter calculated in step S1921 in association with the environment information input in step S1903 and the position information input in step S1903.

The parameter generation method is executed for each combination of an environment of the surrounding area and a position of object. As a result, a range parameter is obtained for each combination of an environment of the surrounding area and a position of object.

Then, each range parameter is registered in the parameter database 191 in association with environment information and position information.

### Effects of First Embodiment

The sensor diagnosis device 100 can decide an appropriate normal range according to the environment of the surrounding area and the position of the object. As a result, the sensor diagnosis device 100 has the effect of being able to determine the state of the sensor group 200 more accurately.

### Implementation Examples of First Embodiment

The range parameter to be used may be different depending on the type of object. In this case, the first embodiment is implemented as described below. Differences from what has been described above will be mainly described.

The parameter generation method (see FIG. 6) is carried out for each combination of an environment of the surrounding area, a position of object, and a type of object.

In step S1903, the operator inputs environment information, position information, and type information into the computer. The type information identifies the type of the object.

In step S1922, the computer saves the range parameter in association with the environment information, the position information, and the type information.

The sensor diagnosis method (see FIG. 2) will be described.

In step S120, the object detection unit 120 calculates a position information group of an object based on the sensor data group. Furthermore, the object detection unit 120 determines the type of the object based on at least one piece of sensor data. The type of the object is determined as described below. The object detection unit 120 selects one piece of sensor data, performs data processing on the selected sensor data, and determines the type of the object based on the result of the data processing. At this time, for determining the type of the object, conventional data processing can be used according to the type of the sensor data. For example, the object detection unit 120 performs image processing using image data so as to determine the type of an object captured in an image. The type of the object may be determined by sensor fusion. In this case, the object detection unit 120 determines the type of the object using two or more pieces of sensor data. The method of sensor fusion for this determination may be any method. For example, the object detection unit 120 determines the type of the object for each piece of sensor data, and decides the type of the object by majority decision based on the determination results.

In step S140, the normal range decision unit 140 decides a normal range based on the environment of the surrounding area and the type of the object. Based on FIG. 3, the normal range decision process (S140) will be described.

In step S141, the normal range decision unit 140 selects one sensor based on the environment of the surrounding area and the type of the object. For example, the normal range decision unit 140 uses a sensor table to select a sensor corresponding to the environment of the surrounding area and the type of the object. The sensor table is a table in which sensors and sets of an environment and a type of object are associated with each other, and is prestored in the storage unit 190.

In step S143, the normal range decision unit 140 acquires a range parameter corresponding to the environment of the surrounding area, the type of the object, and the position information from the parameter database 191.

The state determination unit 150 may calculate a rate of position information within the normal range.

The state determination unit 150 may determine a deterioration level of the sensor group 200 based on the rate of position information within the normal range or the rate of position information outside the normal range. The deterioration level of the sensor group 200 is an example of information indicating the state of the sensor group 200.

The state determination unit 150 may determine the deterioration level of the sensor group 200 together with determining that the sensor group 200 is normal or anomalous, or may determine the deterioration level of the sensor group 200 instead of determining that the sensor group 200 is normal or anomalous.

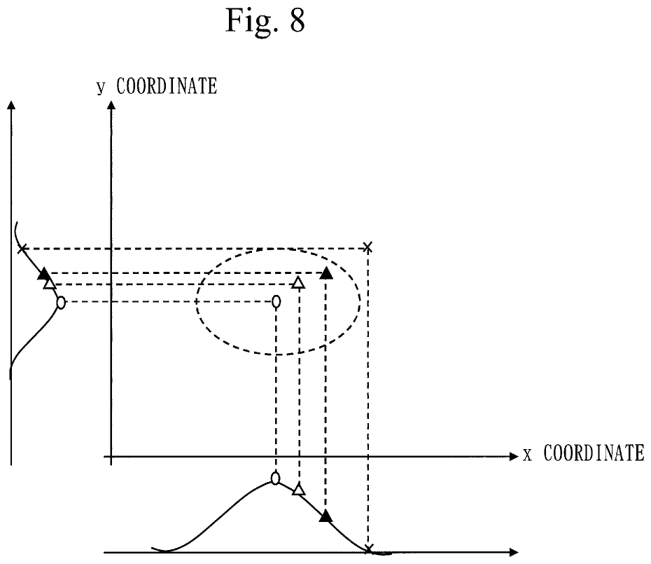

FIG. 8 illustrates changes in the deterioration level of the sensor group 200.

It is considered that the sensor group 200 deteriorates over time. That is, it is considered that the deterioration level of the sensor group 200 changes in the order of “no deterioration”, “low deterioration”, “medium deterioration”, and “high deterioration (anomalous)”.

A blank circle represents a position information group when the deterioration level of the sensor group 200 is “no deterioration”. For example, when the rate of position information within the normal range is 100 percent, the deterioration level of the sensor group 200 is “no deterioration”.

A blank triangle represents a position information group when the deterioration level of the sensor group 200 is “low deterioration”. For example, when the rate of position information within the normal range is equal to or more than 80 percent and less than 100 percent, the deterioration level of the sensor group 200 is “low deterioration”.

A filled triangle represents a position information group when the deterioration level of the sensor group 200 is “medium deterioration”. For example, when the rate of position information within the normal range is equal to or more than 40 percent and less than 80 percent, the deterioration level of the sensor group 200 is “medium deterioration”.

A cross mark represents a position information group when the deterioration level of the sensor group 200 is “high deterioration (anomalous)”. For example, when the rate of position information within the normal range is less than 40 percent, the deterioration level of the sensor group 200 is “high deterioration (anomalous)”.

The marks representing the position information groups gradually shift outward from the center of the normal range (dotted circle).

The state determination unit 150 may determine, for each set of sensors composed of two or more sensors included in the sensor group 200, the state (normal or anomalous) of the set of sensors, and identify an anomalous sensor based on the state of each set of sensors.

For example, assume that a set of the camera 201 and the LIDAR 202 is normal and a set of the camera 201 and the millimeter-wave radar 203 is anomalous. In this case, the state determination unit 150 determines that the millimeter-wave radar 203 is anomalous.

That is, if there are a set of sensors that is normal and a set of sensors that is anomalous, the state determination unit 150 determines that the sensor that is included in the set of sensors that is anomalous and is not included in the set of sensors that is normal is anomalous.

### Second Embodiment

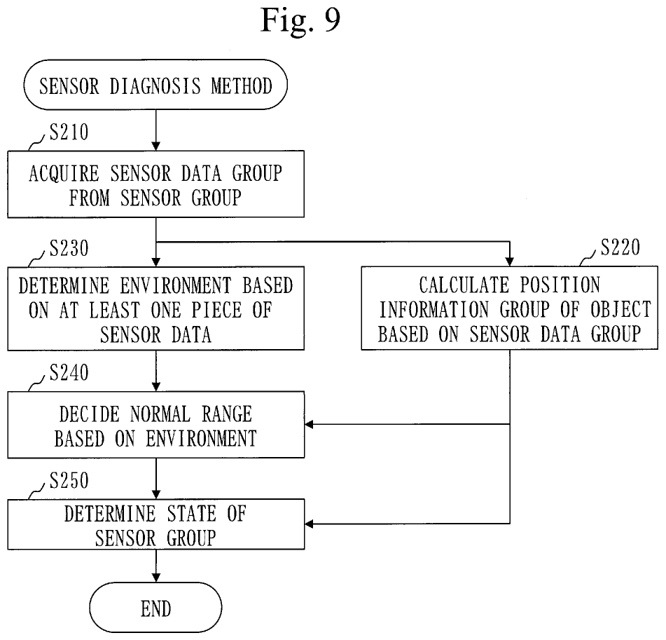

With regard to an embodiment in which the state of the sensor group 200 is determined using feature values of position information of an object, differences from the first embodiment will be mainly described based on FIGS. 9 to 15.

### Description of Configuration

The configuration of the sensor diagnosis device 100 is the same as the configuration (see FIG. 1) in the first embodiment.

### Description of Operation

Based on FIG. 9, a sensor diagnosis method will be described.

Step S210 to step S250 correspond to step S110 to step S150 in the first embodiment (see FIG. 2).

Step S210 to step S230 are the same as step S110 to step S130 in the first embodiment.

In step S240, the normal range decision unit 140 decides a normal range based on the environment determined in step S230.

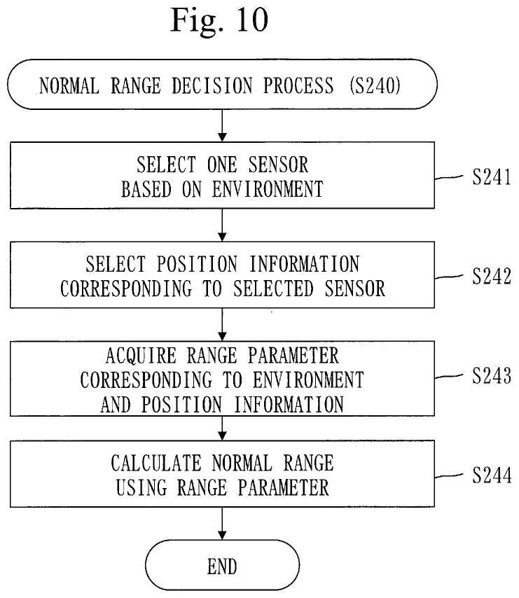

Based on FIG. 10, a procedure for a normal range decision process (S240) will be described.

Step S241 to step S244 correspond to step S141 to step S144 in the first embodiment (see FIG. 3).

Step S241 to step S243 are the same as step S141 to step S143 in the first embodiment.

In step S244, the normal range decision unit 140 calculates a normal range using the range parameter acquired in step S243.

A feature value of position information will be referred to as a position feature value.

The normal range is a range of feature values of normal position information, that is, a range of normal position feature values.

A position feature value is given to position information of an object by a feature extraction technique.

A specific example of the feature extraction technique is principal component analysis.

A specific example of the position feature value is a feature value based on principal component analysis, that is, a principal component score.

The principal component score may be one value for one principal component or two or more values for two or more principal components.

The normal range is calculated as described below.

The range parameter represents a distribution of normal position feature values. For example, the range parameter is the average of normal position feature values and the standard deviation (σ) of normal position feature values.

The normal range decision unit 140 calculates the normal range according to the distribution of normal position feature values. For example, the normal range decision unit 140 calculates a range of the average ±2σ. The calculated range is used as the normal range. However, “1σ”, “3σ”, or the like may be used in place of “2σ”.

Referring back to FIG. 9, step S250 will be described.

In step S250, the state determination unit 150 determines the state of the sensor group 200 based on the position information group calculated in step S220 and the normal range decided in step S240.

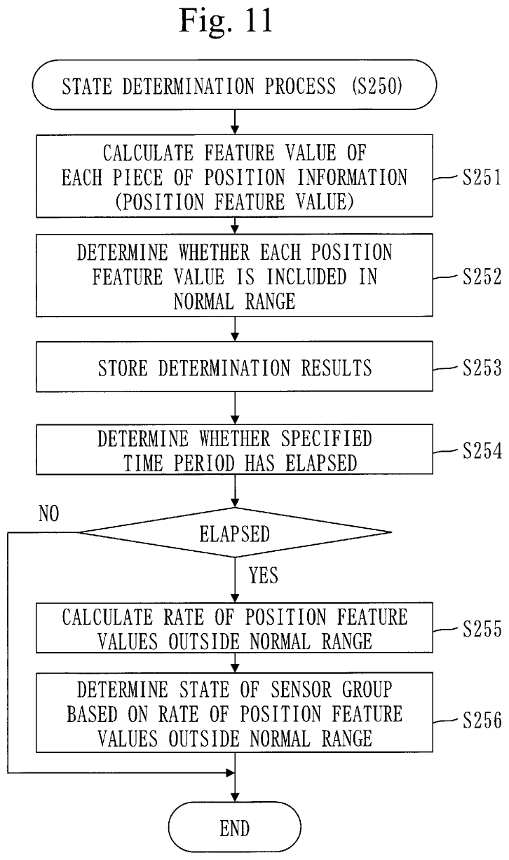

Based on FIG. 11, a procedure for a state determination process (S250) will be described.

Step S252 to step S256 correspond to step S151 to step S155 in the first embodiment (see FIG. 4).

In step S251, the state determination unit 150 calculates a feature value of each piece of position information calculated in step S220, that is, a position feature value.

If a plurality of objects are detected in step S220, the state determination unit 150 calculates a position feature value for each piece of position information for each object.

A specific example of the position feature value is a principal component score. The principal component score is calculated as described below.

In the parameter database 191, a range parameter and a conversion formula are registered for each combination of environment information and position information.

The conversion formula is a formula for converting position information into a principal component score, and is expressed by a matrix, for example.

First, the state determination unit 150 acquires the conversion formula registered with the range parameter selected in step S243 from the parameter database 191.

Then, the state determination unit 150 substitutes the position information into the conversion formula and computes the conversion formula. By this, the principal component score is calculated.

However, a different type of position feature value other than the principal component score may be calculated.

In step S252, the state determination unit 150 compares each position feature value calculated in step S251 with the normal range decided in step S240.

Then, based on the comparison result, the state determination unit 150 determines whether each position feature value calculated in step S251 is included in the normal range decided in step S240.

If a plurality of objects are detected in step S220, the state determination unit 150 determines, for each object, whether each position feature value is included in the normal range.

In step S253, the state determination unit 150 stores the determination results obtained in step S252 in the storage unit 190.

In step S254, the state determination unit 150 determines whether a specified time period has elapsed. This specified time period is a time period predetermined for the state determination process (S250).

For example, the state determination unit 150 determines whether the specified time period has newly elapsed from the previous time point when the specified time period had elapsed.

If the specified time period has elapsed, processing proceeds to step S255.

If the specified time period has not elapsed, the state determination process (S250) ends.

In step S255, the state determination unit 150 calculates the rate of position feature values outside the normal range using the determination results stored in step S253 during the specified time period.

In step S256, the state determination unit 150 determines the state of the sensor group 200 based on the rate of position feature values outside the normal range.

The state of the sensor group 200 is determined as described below.

The state determination unit 150 compares the rate of position feature values outside the normal range with a rate threshold. This rate threshold is a threshold predetermined for the state determination process (S250).

If the rate of position feature values outside the normal range is greater than the rate threshold, the state determination unit 150 determines that the sensor group 200 is anomalous.

If the rate of position feature values outside the normal range is smaller than the rate threshold, the state determination unit 150 determines that the sensor group 200 is normal.

If the rate of position feature values outside the normal range is equal to the rate threshold, the state determination unit 150 may determine that the sensor group 200 is anomalous, or may determine that the sensor group 200 is normal.

### Supplement to Second Embodiment

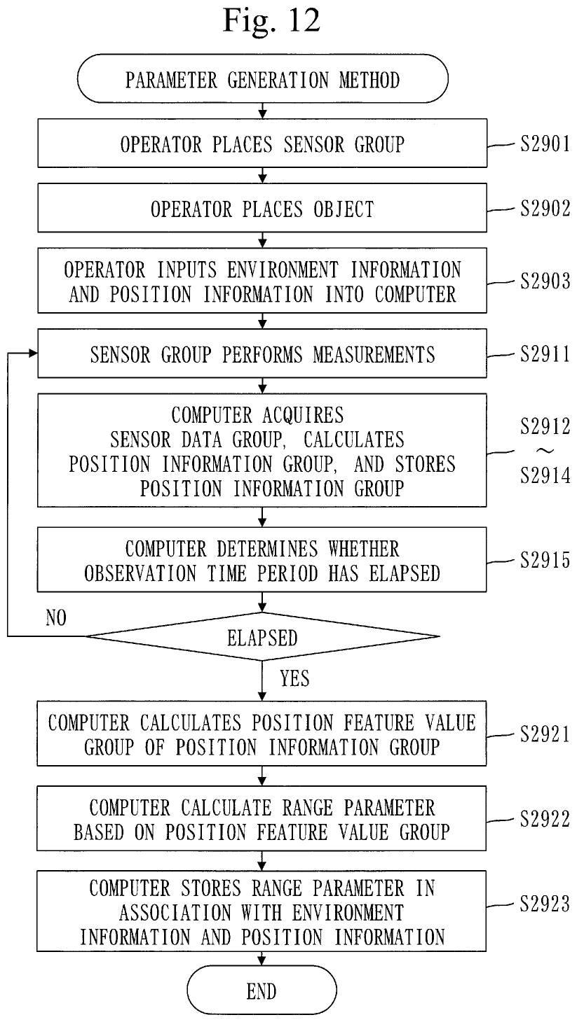

Based on FIG. 12, a parameter generation method will be described.

Step S2901 to step S2903 are the same as step S1901 to step S1903 in the first embodiment.

Step S2911 to step S2915 are the same as step S1911 to step S1915 in the first embodiment.

In step S2921, the computer calculates one or more position feature value groups for one or more position information groups stored in step S2914 during the observation time period. That is, the computer calculates a feature value of each piece of position information (position feature value).

A specific example of the position feature value is a principal component score. The principal component score is calculated as described below.

First, the computer performs principal component analysis on the position information group to decide a principal component.

Then, the computer calculates the principal component score of each piece of position information with respect to the decided principal component.

However, a different type of position feature value other than the principal component score may be calculated.

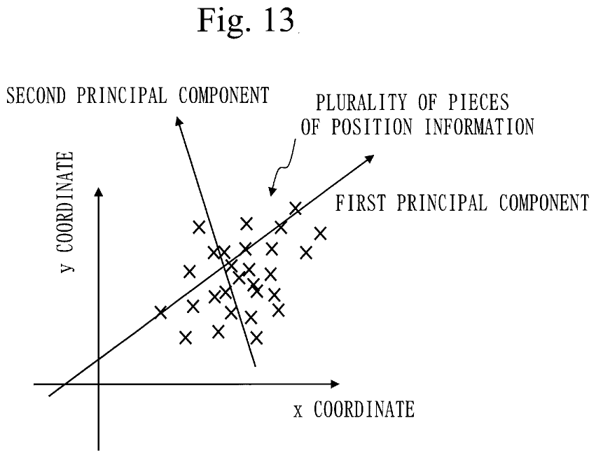

FIG. 13 illustrates a relationship among a plurality of pieces of position information, a first principal component, and a second principal component.

The plurality of pieces of position information constitute one or more position information groups.

One cross mark represents one piece of position information. Position information is two-dimensional coordinate values (x, y).

For example, the computer performs principal component analysis on the plurality of pieces of position information to decide each of the first principal component and the second principal component. Then, the computer calculates a first principal component score and a second principal component score for each piece of position information. The first principal component score is a score (coordinate value) of position information in the first principal component. The second principal component score is a score (coordinate value) of position information in the second principal component.

Referring back to FIG. 12, the description will be continued from step S2922.

In step S2922, the computer calculates a range parameter based on the one or more position feature value groups calculated in step S2921.

The range parameter is calculated as described below.

First, the computer calculates a normal distribution for the one or more position feature value groups.

Then, the computer calculates the average in the calculated normal distribution. Furthermore, the computer calculates the standard deviation in the calculated normal distribution. A set of the calculated average and the calculated standard deviation is used as the range parameter.

However, the computer may calculate a probability distribution other than the normal distribution. The computer may calculate a range parameter different from the set of the average and the standard deviation.

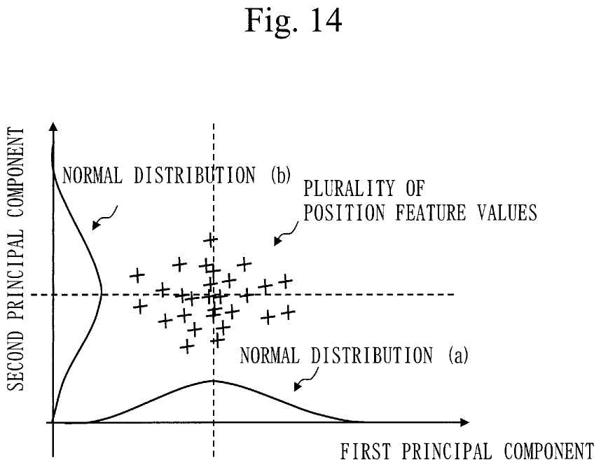

FIG. 14 illustrates a relationship among a plurality of position feature values, a normal distribution (a), and a normal distribution (b).

The plurality of position feature values constitute one or more position feature value groups.

One cross mark represents one position feature value. Specifically, one cross mark represents two-dimensional feature values (a, b). The feature value (a) is a first principal component score, and the feature value (b) is a second principal component score. The normal distribution (a) is the normal distribution in the first principal component. The normal distribution (b) is the normal distribution in the second principal component.

For example, the computer calculates the normal distribution (a) and the normal distribution (b) for the plurality of position feature values. Then, the computer calculates a set of the average and the standard deviation for each of the normal distribution (a) and the normal distribution (b).

Referring back to FIG. 12, step S2923 will be described.

In step S2923, the computer stores the range parameter calculated in step S2922 in association with the environment information input in step S2903 and the position information input in step S2903.

### Effects of Second Embodiment

The sensor diagnosis device 100 can determine the state of the sensor group 200, using feature values of position information of an object. As a result, the sensor diagnosis device 100 has the effect of being able to determine the state of the sensor group 200 more accurately.

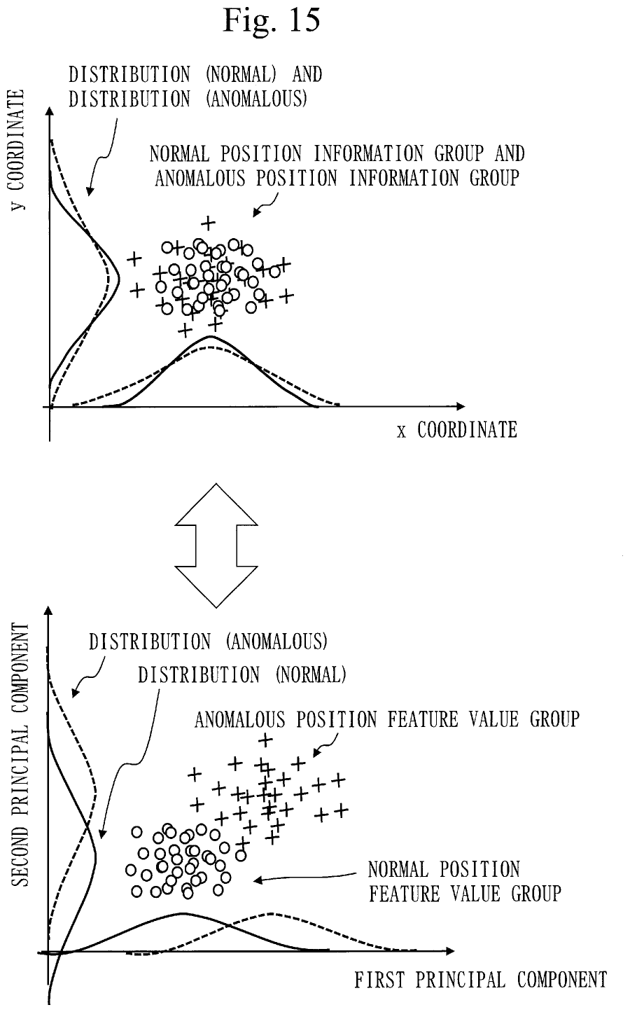

FIG. 15 illustrates distributions of position information and distributions of position feature values.

A blank circle represents normal position information or a normal position feature value.

A cross mark represents anomalous position information or an anomalous position feature value.

A solid line represents a normal distribution of normal position information or normal position feature values (distribution (normal)).

A dashed line represents a normal distribution of anomalous position information or anomalous position feature values (distribution (anomalous)).

As indicated in FIG. 15, a difference between the distribution of normal position feature values and the distribution of anomalous position feature values is greater than a difference between the distribution of normal position information and the distribution of anomalous position information. For this reason, it is easier to distinguish a normal position feature value group and an anomalous position feature value group than to distinguish a normal position information group and an anomalous position information group.

Therefore, by using position feature values, the state of the sensor group 200 can be determined more accurately.

### Implementation Examples of Second Embodiment

As in the implementation example of the first embodiment, the range parameter to be used may be different depending on the type of object.

The state determination unit 150 may calculate the rate of position feature values within the normal range.

The state determination unit 150 may determine the deterioration level of the sensor group 200 based on the rate of position feature values within the normal range or the rate of position feature values outside the normal range. The deterioration level of the sensor group 200 is an example of information indicating the state of the sensor group 200.

The state determination unit 150 may determine the deterioration level of the sensor group 200 together with determining that the sensor group 200 is normal or anomalous, or may determine the deterioration level of the sensor group 200 instead of determining that the sensor group 200 is normal or anomalous.

As in the implementation example of the first embodiment, the state determination unit 150 may identify an anomalous sensor based on the state of each set of sensors.

### Third Embodiment

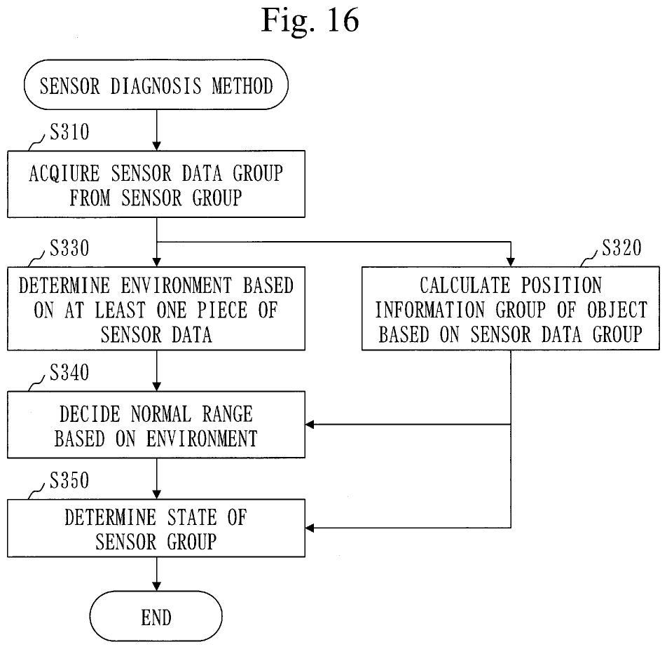

With regard to an embodiment in which a range parameter is calculated by computing a parameter calculation formula, differences from the first embodiment will be mainly described based on FIGS. 16 to 19.

### Description of Configuration

The configuration of the sensor diagnosis device 100 is the same as the configuration in the first embodiment (see FIG. 1).

However, in the parameter database 191, a parameter calculation formula is registered for each piece of environment information, instead of a range parameter being registered for each combination of environment information and position information. The parameter calculation formula is a formula for calculating a range parameter.

### Description of Operation

Based on FIG. 16, a sensor diagnosis method will be described.

Step S310 to step S350 correspond to step S110 to step S150 in the first embodiment (see FIG. 2).

Step S310 to step S330 are the same as step S110 to step S130 in the first embodiment.

In step S340, the normal range decision unit 140 decides a normal range based on the environment determined in step S330.

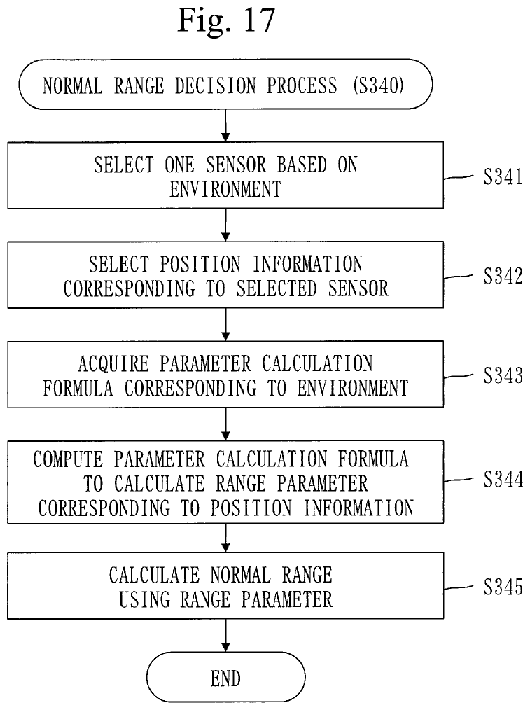

Based on FIG. 17, a procedure for a normal range decision process (S340) will be described.

Step S341 corresponds to step S141 in the first embodiment.

In step S341, the normal range decision unit 140 selects one sensor based on the environment determined in step S330.

Step S342 corresponds to step S142 in the first embodiment.

In step S342, the normal range decision unit 140 selects position information corresponding to the sensor selected in step S341 from the position information group calculated in step S320.

In step S343, the normal range decision unit 140 acquires a parameter calculation formula corresponding to the environment determined in step S330 from the parameter database 191.

In step S344, the normal range decision unit 140 computes the parameter calculation formula acquired in step S343 to calculate a range parameter corresponding to the position information selected in step S342.

The range parameter is calculated as described below.

The normal range decision unit 140 substitutes the position information into the parameter calculation formula and computes the parameter calculation formula. By this, the range parameter corresponding to the position information is calculated.

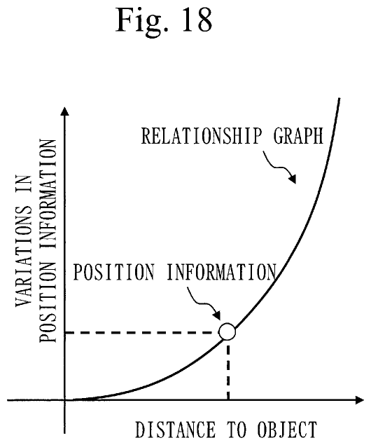

FIG. 18 illustrates a relationship graph.

The relationship graph represents a relationship between the distance to an object and variations in position information. A formula representing the relationship graph corresponds to a parameter calculation formula.

The distance to the object correlates with the position information of the object. That is, the distance to the object corresponds to the position information of the object.

The variations in position information indicate the size of the range of normal position information. That is, the variations in position information correspond to the range parameter.

Referring back to FIG. 17, step S345 will be described.

Step S345 corresponds to step S144 in the first embodiment.

In step S345, the normal range decision unit 140 calculates a normal range using the range parameter calculated in step S344.

Referring back to FIG. 16, step S350 will be described.

Step S350 is the same as step S150 in the first embodiment.

### Supplement to Third Embodiment

A method for generating a parameter calculation formula will be described.

The parameter generation method (see FIG. 6) is executed for each combination of an environment of the surrounding area and a position of object. By this, a range parameter is obtained for each combination of environment information and position information.

The computer generates a relationship formula of the position information and the range parameter for each piece of environment information. The generated relationship formula is used as the parameter calculation formula.

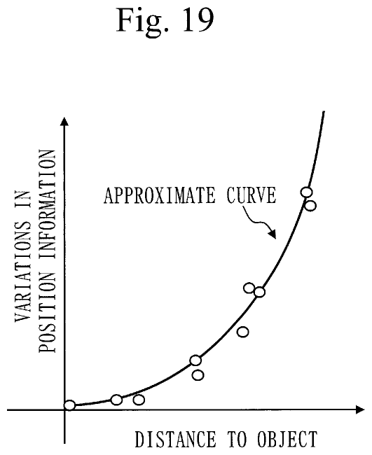

FIG. 19 illustrates an approximate curve.

A blank circle represents position information.

### The approximate curve represents a relationship between the “distance to an object” based on each piece of position information and “variations” in pieces of position information.

The parameter calculation formula corresponds to a formula representing the approximate curve (approximation formula).

### Effects of Third Embodiment

The sensor diagnosis device 100 calculates a range parameter by computing a parameter calculation formula, and uses the calculated range parameter to calculate a normal range. This allows the sensor diagnosis device 100 to decide a more appropriate normal range. As a result, the sensor diagnosis device 100 has the effect of being able to determine the state of the sensor group 200 more accurately.

### Implementation Examples of Third Embodiment

The range parameter to be used may be different depending on the type of object. In this case, the third embodiment is implemented as described below. Differences from what has been described will be mainly described.

The parameter generation method (see FIG. 6) is carried out for each combination of an environment of the surrounding area, a position of object, and a type of object.

In step S1903, the operator inputs environment information, position information, and type information into the computer. The type information identifies the type of the object.

In step S1922, the computer stores the range parameter in association with the environment information, the position information, and the type information.

Then, the computer generates a relationship formula of the position information and the range parameter for each combination of environment information and type information. The generated relationship formula is used as the parameter calculation formula.

The sensor diagnosis method (see FIG. 16) will be described.

In step S320, the object detection unit 120 calculates a position information group of an object based on the sensor data group. Furthermore, the object detection unit 120 determines the type of the object based on at least one piece of sensor data. The type of the object is determined as described below. The object detection unit 120 selects one piece of sensor data, performs data processing on the selected sensor data, and determines the type of the object based on the result of the data processing. At this time, for determining the type of the object, conventional data processing can be used according to the type of the sensor data. For example, the object detection unit 120 performs image processing using image data so as to determine the type of an object captured in an image. The type of the object may be determined by sensor fusion. In this case, the object detection unit 120 determines the type of the object using two or more pieces of sensor data. The method of sensor fusion for this determination may be any method. For example, the object detection unit 120 determines the type of the object for each piece of sensor data, and decides the type of the object by majority decision based on the determination results.

In step S340, the normal range decision unit 140 decides a normal range based on the environment of the surrounding area and the type of the object. Based on FIG. 17, the normal range decision process (S340) will be described.

In step S341, the normal range decision unit 140 selects one sensor based on the environment of the surrounding area and the type of the object. For example, the normal range decision unit 140 uses a sensor table to select a sensor corresponding to the environment of the surrounding area and the type of the object. The sensor table is a table in which sensors and sets of an environment and a type of object are associated with each other, and is prestored in the storage unit 190.

In step S343, the normal range decision unit 140 acquires a parameter calculation formula corresponding to the environment of the surrounding area and the type of the object from the parameter database 191.

As in the implementation example of the first embodiment, the state determination unit 150 may determine the deterioration level of the sensor group 200 based on the rate of position information within the normal range or the rate of position information outside the normal range.

As in the implementation example of the first embodiment, the state determination unit 150 may identify an anomalous sensor based on the state of each set of sensors.

### Fourth Embodiment

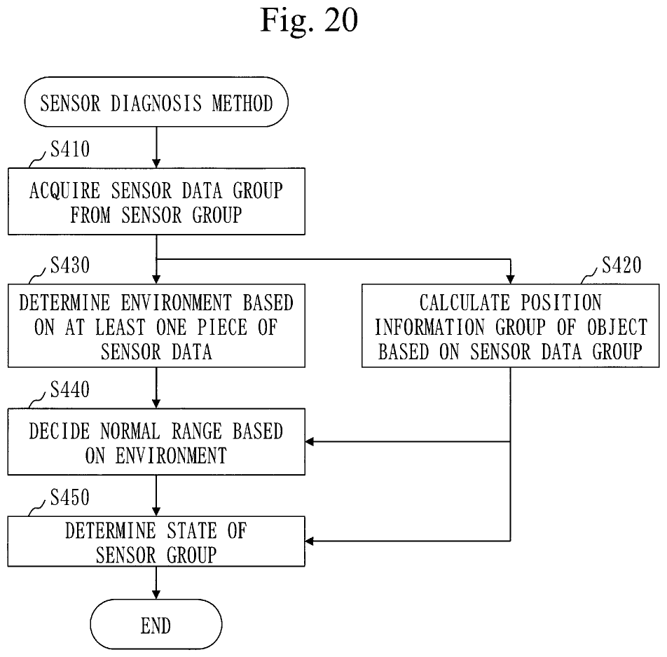

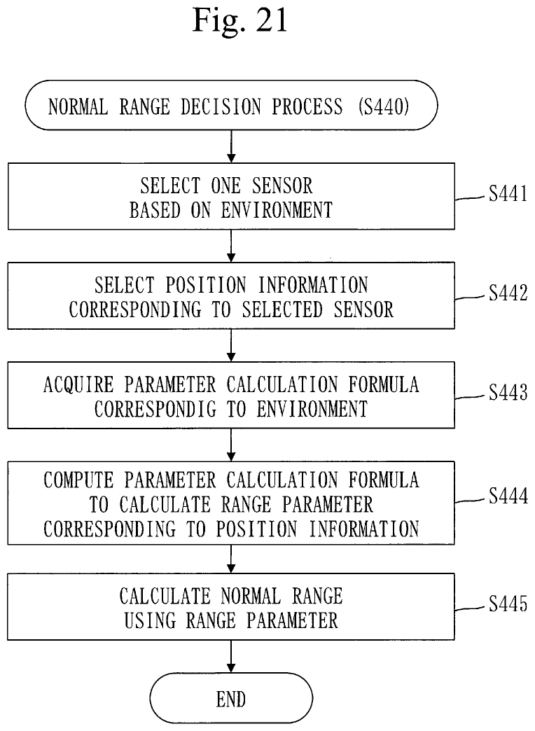

With regard to an embodiment in which a range parameter is calculated by computing a parameter calculation formula, differences from the second embodiment will be mainly described based on FIG. 20 and FIG. 21.

### Description of Configuration

The configuration of the sensor diagnosis device 100 is the same as the configuration in the first embodiment (see FIG. 1).

However, in the parameter database 191, a parameter calculation formula is registered for each piece of environment information, instead of a range parameter being registered for each combination of environment information and position information. The parameter calculation formula is a formula for calculating a range parameter.

### Description of Operation

Based on FIG. 20, a sensor diagnosis method will be described.

Step S410 to step S450 correspond to step S210 to step S250 in the second embodiment (see FIG. 9).

Step S410 to step S430 are the same as step S210 to step S230 in the second embodiment.

In step S440, the normal range decision unit 140 decides a normal range based on the environment determined in step S430.

Based on FIG. 21, a procedure for a normal range decision process (S440) will be described.

Step S441 corresponds to step S241 in the second embodiment.

In step S441, the normal range decision unit 140 selects one sensor based on the environment determined in step S430.

Step S442 corresponds to step S242 in the second embodiment.

In step S442, the normal range decision unit 140 selects position information corresponding to the sensor selected in step S441 from the position information group calculated in step S420.

In step S443, the normal range decision unit 140 acquires a parameter calculation formula corresponding to the environment determined in step S430 from the parameter database 191.

In step S444, the normal range decision unit 140 computes the parameter calculation formula acquired in step S443 so as to calculate a range parameter corresponding to the position information selected in step S442.

The range parameter is calculated as described below.

The normal range decision unit 140 substitutes the position information into the parameter calculation formula and computes the parameter calculation formula. By this, the range parameter corresponding to the position information is calculated.

Step S445 corresponds to step S244 in the second embodiment.

In step S445, the normal range decision unit 140 calculates a normal range using the range parameter calculated in step S444.

Referring back to FIG. 20, step S450 will be described.

Step S450 is the same as step S250 in the second embodiment.

### Supplement to Fourth Embodiment

A method for generating a parameter calculation formula will be described.

The parameter generation method (see FIG. 12) is executed for each combination of an environment of the surrounding area and a position of object. By this, a range parameter is obtained for each combination of environment information and position information.

The computer generates a relationship formula of the position information and the range parameter for each piece of environment information. The generated relation formula is used as the parameter calculation formula.

### Effects of Fourth Embodiment

The sensor diagnosis device 100 can determine the state of the sensor group 200 using feature values of position information of an object. As a result, the sensor diagnosis device 100 has the effect of being able to determine the state of the sensor group 200 more accurately.

The sensor diagnosis device 100 calculates a range parameter by computing a parameter calculation formula, and uses the calculated range parameter to calculate a normal range. This allows the sensor diagnosis device 100 to decide a more appropriate normal range. As a result, the sensor diagnosis device 100 has the effect of being able to determine the state of the sensor group 200 more accurately.

### Implementation Examples of Fourth Embodiment

As in the implementation example of the third embodiment, the range parameter to be used may be different depending on the type of object.

As in the implementation example of the second embodiment, the state determination unit 150 may determine the deterioration level of the sensor group 200 based on the rate of position feature values within the normal range or the rate of position feature values outside the normal range.

As in the implementation example of the first embodiment, the state determination unit 150 may identify an anomalous sensor based on the state of each set of sensors.

### Supplement to Embodiments

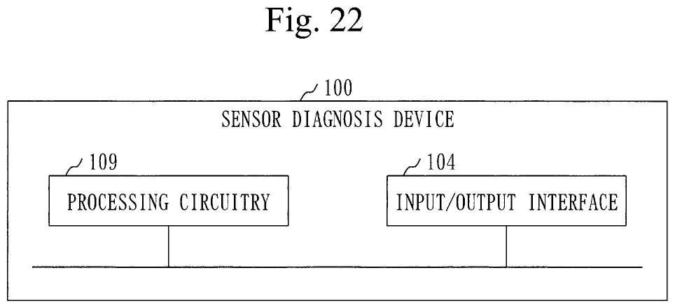

Based on FIG. 22, a hardware configuration of the sensor diagnosis device 100 will be described.

The sensor diagnosis device 100 includes processing circuitry 109.

The processing circuitry 109 is hardware that realizes the data acquisition unit 110, the object detection unit 120, the environment determination unit 130, the normal range decision unit 140, and the state determination unit 150.

The processing circuitry 109 may be dedicated hardware, or may be the processor 101 that executes programs stored in the memory 102.

When the processing circuitry 109 is dedicated hardware, the processing circuitry 109 is, for example, a single circuit, a composite circuit, a programmed processor, a parallel-programmed processor, an ASIC, an FPGA, or a combination of these.

ASIC is an abbreviation for Application Specific Integrated Circuit.

FPGA is an abbreviation for Field Programmable Gate Array.

The sensor diagnosis device 100 may include a plurality of processing circuits as an alternative to the processing circuitry 109. The plurality of processing circuits share the functions of the processing circuitry 109.

In the sensor diagnosis device 100, some of the functions may be realized by dedicated hardware, and the rest of the functions may be realized by software or firmware.

As described above, each function of the sensor diagnosis device 100 can be realized by hardware, software, firmware, or a combination of these.

The embodiments are examples of preferred embodiments, and are not intended to limit the technical scope of the present invention. The embodiments may be partially implemented, or may be implemented in combination with another embodiment. The procedures described using flowcharts or the like may be modified as appropriate.

Each “unit”, which is an element of the sensor diagnosis device 100, may be interpreted as “process” or “step”.

### REFERENCE SIGNS LIST

100: sensor diagnosis device, 101: processor, 102: memory, 103: auxiliary storage device, 104: input/output interface, 109: processing circuitry, 110: data acquisition unit, 120: object detection unit, 130: environment determination unit, 140: normal range decision unit, 150: state determination unit, 190: storage unit, 191: parameter database, 200: sensor group, 201: camera, 202: LIDAR, 203: millimeter-wave radar, 204: sonar.

1. A sensor diagnosis device comprising:
processing circuitry to:
acquire a sensor data group from a sensor group including a plurality of sensors of different types,
calculate a position information group of an object existing in an area surrounding the sensor group based on the acquired sensor data group,
determine an environment of the area surrounding the sensor group based on at least one piece of sensor data in the acquired sensor data group,
decide a normal range for the calculated position information group based on a parameter database in which parameter data associated with environment information and position information is registered and the determined environment, and
determine a state of the sensor group based on the calculated position information group and the decided normal range,
wherein the parameter data is a parameter calculation formula that represents a distribution of position information of a placed object, the position information of the placed object being obtained by a sensor group that is normal in a situation where the placed object is placed at a position identified by the position information in an environment identified by the environment information, and
wherein the processing circuitry selects one sensor from the sensor group based on the determined environment, selects position information corresponding to the selected sensor from the position information group, acquires a parameter calculation formula corresponding to the determined environment as the parameter data, computes the acquired parameter calculation formula to calculate a range parameter corresponding to the selected position information, and uses the calculated range parameter to calculate a range of normal position information as the normal range.

2. The sensor diagnosis device according to claim 1,
wherein the processing circuitry determines whether each piece of position information in the position information group is included in the normal range at each time point in a specified time period, calculates a rate of position information outside the normal range in the specified time period, and determines the state of the sensor group based on the calculated rate.

3. The sensor diagnosis device according to claim 1,
wherein the processing circuitry calculates at least one piece of position information in the position information group, using two or more pieces of sensor data acquired from two or more sensors.

4. The sensor diagnosis device according to claim 1,
wherein the processing circuitry selects two or more sensors from the sensor group, and determines the environment using two or more pieces of sensor data acquired from the two or more selected sensors.

5. A sensor diagnosis device comprising:
processing circuitry to:
acquire a sensor data group from a sensor group including a plurality of sensors of different types,
calculate a position information group of an object existing in an area surrounding the sensor group based on the acquired sensor data group,
determine an environment of the area surrounding the sensor group based on at least one piece of sensor data in the acquired sensor data group,
decide a normal range for the calculated position information group based on a parameter database in which parameter data associated with environment information and position information is registered and the determined environment, and
determine a state of the sensor group based on the calculated position information group and the decided normal range,
wherein the parameter data is a parameter calculation formula that represents a distribution of position information of a placed object, the position information of the placed object being obtained by a sensor group that is normal in a situation where the placed object is placed at a position identified by the position information in an environment identified by the environment information,
wherein the processing circuitry selects one sensor from the sensor group based on the determined environment, selects position information corresponding to the selected sensor from the position information group, acquires a parameter calculation formula corresponding to the determined environment as the parameter data, computes the acquired parameter calculation formula to calculate a range parameter corresponding to the selected position information, and uses the calculated range parameter to calculate a range of normal position feature values as the normal range, and
wherein a position feature value is a feature value of position information.

6. The sensor diagnosis device according to claim 5,
wherein the processing circuitry calculates a position feature value of each piece of position information in the position information group at each time point in a specified time period, determines whether each position feature value is included in the normal range at each time point in the specified time period, calculates a rate of position feature values outside the normal range in the specified time period, and determines the state of the sensor group based on the calculated rate.

7. The sensor diagnosis device according to claim 5,
wherein the processing circuitry calculates at least one piece of position information in the position information group, using two or more pieces of sensor data acquired from two or more sensors.

8. The sensor diagnosis device according to claim 5,
wherein the processing circuitry selects two or more sensors from the sensor group, and determines the environment using two or more pieces of sensor data acquired from the two or more selected sensors.

9. A non-transitory computer readable medium storing a sensor diagnosis program for causing a computer to execute:
a data acquisition process of acquiring a sensor data group from a sensor group including a plurality of sensors of different types;
an object detection process of calculating a position information group of an object existing in an area surrounding the sensor group based on the acquired sensor data group;
an environment determination process of determining an environment of the area surrounding the sensor group based on at least one piece of sensor data in the acquired sensor data group;
a normal range decision process of deciding a normal range for the calculated position information group based on a parameter database in which parameter data associated with environment information and position information is registered and the determined environment; and
a state determination process of determining a state of the sensor group based on the calculated position information group and the decided normal range,
wherein the parameter data is a parameter calculation formula that represents a distribution of position information of a placed object, the position information of the placed object being obtained by a sensor group that is normal in a situation where the placed object is placed at a position identified by the position information in an environment identified by the environment information, and
wherein the normal range decision process selects one sensor from the sensor group based on the determined environment, selects position information corresponding to the selected sensor from the position information group, acquires a parameter calculation formula corresponding to the determined environment as the parameter data, computes the acquired parameter calculation formula to calculate a range parameter corresponding to the selected position information, and uses the calculated range parameter to calculate a range of normal position information as the normal range.

10. A non-transitory computer readable medium storing a sensor diagnosis program for causing a computer to execute:
a data acquisition process of acquiring a sensor data group from a sensor group including a plurality of sensors of different types;
an object detection process of calculating a position information group of an object existing in an area surrounding the sensor group based on the acquired sensor data group;
an environment determination process of determining an environment of the area surrounding the sensor group based on at least one piece of sensor data in the acquired sensor data group;
a normal range decision process of deciding a normal range for the calculated position information group based on a parameter database in which parameter data associated with environment information and position information is registered and the determined environment; and
a state determination process of determining a state of the sensor group based on the calculated position information group and the decided normal range,
wherein the parameter data is a parameter calculation formula that represents a distribution of position information of a placed object, the position information of the placed object being obtained by a sensor group that is normal in a situation where the placed object is placed at a position identified by the position information in an environment identified by the environment information,
wherein the normal range decision process selects one sensor from the sensor group based on the determined environment, selects position information corresponding to the selected sensor from the position information group, acquires a parameter calculation formula corresponding to the determined environment as the parameter data, computes the acquired parameter calculation formula to calculate a range parameter corresponding to the selected position information, and uses the calculated range parameter to calculate a range of normal position feature values as the normal range, and
wherein a position feature value is a feature value of position information.

11. A sensor diagnosis device comprising:
processing circuitry to:
acquire a sensor data group from a sensor group including a plurality of sensors of different types,
calculate a position information group of an object existing in an area surrounding the sensor group based on the acquired sensor data group,
determine an environment of the area surrounding the sensor group based on at least one piece of sensor data in the acquired sensor data group,
decide a normal range for the calculated position information group based on the determined environment, and
determine a state of the sensor group based on the calculated position information group and the decided normal range,
wherein the processing circuitry selects one sensor from the sensor group based on the determined environment, selects position information corresponding to the selected sensor from the position information group, acquires a parameter calculation formula corresponding to the determined environment, computes the acquired parameter calculation formula to calculate a range parameter corresponding to the selected position information, and uses the calculated range parameter to calculate a range of normal position information as the normal range.

12. A sensor diagnosis device comprising:
processing circuitry to:
acquire a sensor data group from a sensor group including a plurality of sensors of different types,
calculate a position information group of an object existing in an area surrounding the sensor group based on the acquired sensor data group,
determine an environment of the area surrounding the sensor group based on at least one piece of sensor data in the acquired sensor data group,
decide a normal range for the calculated position information group based on the determined environment, and
determine a state of the sensor group based on the calculated position information group and the decided normal range,
wherein the processing circuitry selects one sensor from the sensor group based on the determined environment, selects position information corresponding to the selected sensor from the position information group, acquires a parameter calculation formula corresponding to the determined environment, computes the acquired parameter calculation formula to calculate a range parameter corresponding to the selected position information, and uses the calculated range parameter to calculate a range of normal position feature values as the normal range, and
wherein a position feature value is a feature value of position information.

13. The sensor diagnosis device according to claim 2,
wherein the processing circuitry calculates at least one piece of position information in the position information group, using two or more pieces of sensor data acquired from two or more sensors.

14. The sensor diagnosis device according to claim 13,
wherein the processing circuitry selects two or more sensors from the sensor group, and determines the environment using two or more pieces of sensor data acquired from the two or more selected sensors.

15. The sensor diagnosis device according to claim 2,
wherein the processing circuitry selects two or more sensors from the sensor group, and determines the environment using two or more pieces of sensor data acquired from the two or more selected sensors.

16. The sensor diagnosis device according to claim 3,
wherein the processing circuitry selects two or more sensors from the sensor group, and determines the environment using two or more pieces of sensor data acquired from the two or more selected sensors.

17. The sensor diagnosis device according to claim 6,
wherein the processing circuitry calculates at least one piece of position information in the position information group, using two or more pieces of sensor data acquired from two or more sensors.

18. The sensor diagnosis device according to claim 17,
wherein the processing circuitry selects two or more sensors from the sensor group, and determines the environment using two or more pieces of sensor data acquired from the two or more selected sensors.

19. The sensor diagnosis device according to claim 6,
wherein the processing circuitry selects two or more sensors from the sensor group, and determines the environment using two or more pieces of sensor data acquired from the two or more selected sensors.

20. The sensor diagnosis device according to claim 7,
wherein the processing circuitry selects two or more sensors from the sensor group, and determines the environment using two or more pieces of sensor data acquired from the two or more selected sensors.
